(19) United States
(12) Patent Application Publication
(10) Pub. No.: US 2013/0167677 A1
(43) Pub. Date: Jul. 4, 2013

(54) Over Center Drill Head Gear Shifting System

(71) Applicant: Longyear TM, Inc., South Jordan, UT (US)

(72) Inventor: Anthony Charles William Markham, North Bay (CA)

(73) Assignee: Longyear TM, Inc., South Jordan, UT (US)

(21) Appl. No.: 13/731,372

(22) Filed: Dec. 31, 2012

Related U.S. Application Data
(60) Provisional application No. 61/583,132, filed on Jan. 4, 2012.

(51) Int. Cl. F16H 3/08

(52) U.S. Cl. CPC F16H 3/08
USPC 74/335

(57) ABSTRACT

Aspects of the present invention relate to system and apparatus for shifting gears within a gearbox of a drill head, which can be attached to a drill rig for various drilling operations. In particular, the present disclosure relates to engaging various gears within the gearbox and maintaining the gears in the engaged position such that to prevent the gears from disengaging in response to movements and/or vibrations within the gearbox, the drill head, and/or the drill rig.

### CROSS-REFERENCE TO RELATED APPLICATION

This application claims the benefit of the filing date of U.S. Provisional Patent Application No. 61/583,132, filed Jan. 4, 2012, which is incorporated herein by reference in its entirety.

### BACKGROUND

1. Field of the Invention

Aspects described herein relate generally to drill heads and relate more specifically to systems, methods, and apparatus for engaging and disengaging gears in a drill head.

2. Related Art

Drill rigs generally include an upstanding mast with a mounted drill head. The drill head can be capable of moving along the mast. Additionally, the drill head can receive and engage the upper end of a drill string. The drill head can rotate the drill string and a drill bit mounted to the drill string to drill a formation. The drill string can include a plurality of drill rods that are connected end to end.

During a typical drilling operation, when the drill head reaches the lower end of the mast, the drill string can be clamped and the drill head disconnected from the drill string. An additional length of drill rod can then be added to the end of the drill string, the drill head connected to the new rod, and the drilling process resumed once again. During a drilling operation, depending on the depth of the borehole, numerous drill rods can be added to the drill string in order to reach a desired depth.

Depending on the type of the drilling operation, an operator of the drill rig can choose a particular speed of rotation for the drill head and, consequently, for the drill string. Changing the speed of rotation can typically be accomplished by shifting gears or splines in a gearbox, and/or modulating flow of hydraulic fluid to the motor, which transmits the rotational motion from a drive source to the drill string. For instance, by engaging a small gear, a highest number of revolutions per minute can be achieved (i.e., a higher speed). By contrast, by engaging a larger gear, a lower speed can be achieved and transferred to the drill string.

Within a gearbox, it is possible for a gear to shift out of its intended position if not positively held in place by an applied force. In conventional gearbox assemblies, a locking pin configured to threadingly engage a hole can be used to lock the desired gear in place. In operation, the locking pin must be manually adjusted to engage the hole, leaving room for operator error and wasting time during a drilling operation.

Accordingly, a need exists for improved drill heads capable of securely engaging and disengaging gears without manual operation.

### BRIEF SUMMARY OF THE INVENTION

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

Stated generally, the present disclosure comprises apparatus, systems and methods for shifting a drill head between various configurations.

Stated more specifically, a gear shifting apparatus and system can be configured to engage and disengage gears to control at least one of rate of rotation and torque of a drive shaft of the drill head. In one or more aspects, the gear shifting system can be configured to apply sufficient force to prevent unintentional disengagement of a particular gear configuration during a drilling operation. Additionally, the gear shifting system can shift the gears manually or automatically.

Additional features and advantages of exemplary aspects of the invention will be set forth in the description which follows, and in part will be obvious from the description, or can be learned by the practice of such exemplary aspects. The features and advantages of such aspects can be realized and obtained by means of the instruments and combinations particularly pointed out in the appended claims. These and other features will become more fully apparent from the following description and appended claims, or can be learned by the practice of such exemplary aspects as set forth hereinafter.

### BRIEF DESCRIPTION OF THE DRAWINGS

The accompanying drawings, which are incorporated in and constitute a part of this specification, illustrate aspects and together with the description, serve to explain the principles of the methods and systems.

FIG. 1 illustrates a side view of a gear shifting system in a first position in accordance with at least one aspect of the present invention.

FIG. 2 illustrates a side view of a gear shifting system of FIG. 1 in a second position in accordance with at least one aspect of the present invention.

FIG. 3 is a graph showing one example of over-center spring torque versus degrees of shifter travel for the gear shifting system of FIG. 1.

FIG. 4 illustrates a perspective view of a drilling system that incorporates the gear shifting system of FIG. 1.

### DETAILED DESCRIPTION OF THE INVENTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention provided as an enabling teaching of the invention in its best, currently known aspect. To this end, those skilled in the relevant art will recognize and appreciate that many changes can be made to the various aspects of the invention described herein, while still obtaining the beneficial results described herein. It will also be apparent that some of the desired benefits described herein can be obtained by selecting some of the features described herein without utilizing other features. Accordingly, those who work in the art will recognize that many modifications and adaptations to the present invention are possible and can even be desirable in certain circumstances and are a part described herein. Thus, the following description is provided as illustrative of the principles described herein and not in limitation thereof.

Reference will be made to the drawings to describe various aspects of one or more aspects of the invention. It is to be understood that the drawings are diagrammatic and schematic representations of one or more aspects, and are not limiting of the present disclosure. Moreover, while various drawings are provided at a scale that is considered functional for one or more aspects, the drawings are not necessarily drawn to scale for all contemplated aspects. The drawings thus represent an exemplary scale, but no inference should be drawn from the drawings as to any required scale.

In the following description, numerous specific details are set forth in order to provide a thorough understanding described herein. It will be obvious, however, to one skilled in the art that the present disclosure may be practiced without these specific details. In other instances, well known aspects of drill string technology and, more particularly, shifting gears of a drill head have not been described in particular detail in order to avoid unnecessarily obscuring aspects of the disclosed aspects.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

Aspects of the present disclosure comprise gear shifting apparatus and systems operable to maintain engaged gears in continuous engagement, thereby lessening or preventing unwanted disengagement of the gears. Such a gear shifting system can be configured to apply a predetermined amount of force in a manner that prevents disengagement of the engaged gear. In one aspect, the gear shifting apparatus can be configured to cause the engagement and disengagement of gears within the gearbox through actuating a rotating shifter lever. In additional aspects, the gear shifting system can comprise a tensioning or compressing element (collectively a “force element”) that can be configured to apply torque onto the shifter lever to maintain the lever in a stationary position.

In other aspects, the shifter lever can comprise at least two positions in which the shifter lever causes engagement of at least one gear in the gearbox. In operation, as one example, the shifter lever can cause engagement with a first gear (or gears) within the gearbox in a first position. When switched to a second position, the shifter lever can cause disengagement of the first gear and cause engagement of a second gear (or gears) within the gearbox.

In yet other aspects, the force element can be configured to apply a linear force onto the shifter lever which can be configured to be offset from a center point of rotation of the shifter lever. In operation, the force element can apply a moment or torque onto the shifter lever. In a further aspect, the force element can apply substantially the same torque onto the shifter lever in both the first and second positions. In any event, the moment or torque applied to the shifter lever can be sufficient to prevent unintentional rotation of the shifter lever.

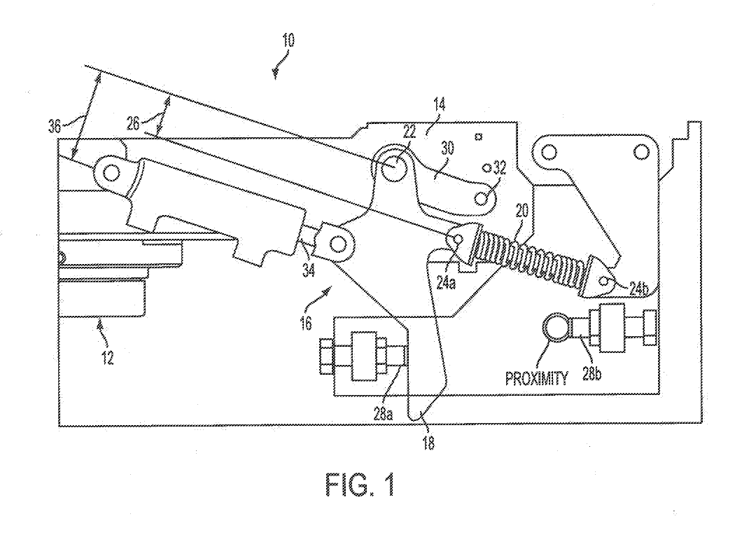

FIG. 1 illustrates a drilling system 10 comprising a drive shaft 12, a drill head 14 having a gearbox, and a gear shifting system 16. The gear shifting system 16 can be configured to cause engagement and disengagement of gears within the gearbox. More specifically, the gear shifting system 16 can cause shifting of the gears within the gearbox such that the gearbox can transmit rotational motion from a drive source (e.g., a hydraulic motor) to the drive shaft 12. For example, the gearbox can reduce or increase the number of revolutions per minute (RPM) from the drive source such that the drive shaft 12 can rotate at a desired speed. Additionally or alternatively, the gearbox can increase torque (by decreasing output RPM) or decrease torque (by increasing output RPM), as desired by an operator of the drilling system 10.

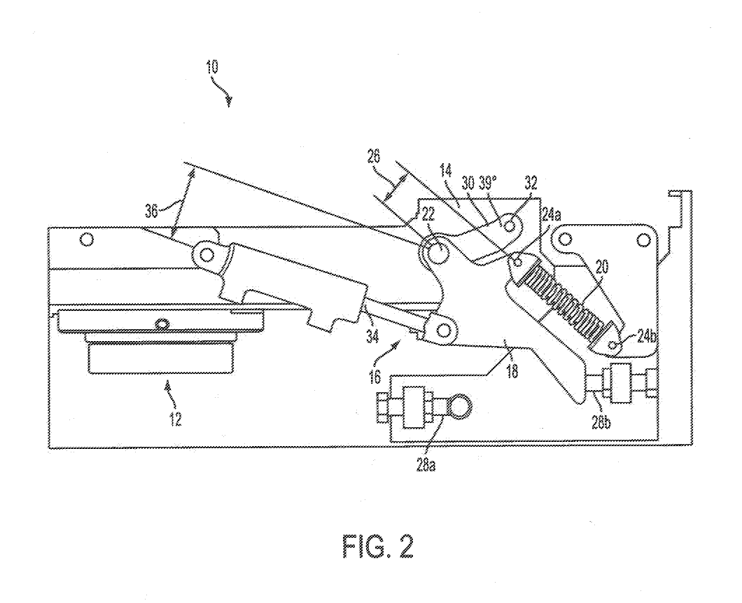

In at least one aspect, the gear shifting system 16 comprises a shifter lever 18 and a force element 20. The gear shifting system 16 can further comprise a shift shaft 22. Rotation of the shift shaft 22 caused by movement of the shifter lever 18 can cause engagement and/or disengagement of at least one gear within the gearbox. In operation, the shifter lever 18 can rotate to a first position (illustrated in FIG. 1) to cause engagement of a first gear within the gearbox. Furthermore, the shifter lever 18 can remain in the first position until and unless moved out of the first position by the operator. The shifter lever 18 can also rotate to a second position (illustrated in FIG. 2), thereby disengaging the first gear and engaging the second gear within the gearbox.

In other aspects, the force element 20 can apply linear force to a portion of the shifter lever 18 to urge the shifter lever 18 to remain in the first position. In further aspects, the force element 20 can pivotally connect to the shifter lever 18 at a connection point 24a that can be offset from the shift shaft 22 by an shifter lever offset distance 26 measured perpendicularly to a direction parallel to the force applied by the force element 20. More particularly, the shifter lever offset distance 26 is the perpendicular distance from the force vector of the force element to the centreline of the rotating shift shaft. The shifter lever offset distance can be used for tracking the change in torque generated by the cylinder throughout the stroke of the shift mechanism.

In operation, force applied at the connection point 24a can generate clockwise or counterclockwise torque on the shifter lever 18, around the shift shaft 22. The torque can be substantially equal to the amount of linear force applied at the connection point 24a multiplied by the offset distance 26. In the first position, the force element 20 can apply clockwise torque to the shifter lever 18 in order to maintain the shifter lever 18 in place and, therefore, the gears of the gearbox in an engaged position.

In yet other aspects of the present disclosure, the force element 20 can be pivotally coupled at a connection point 24B, which can be located on a portion of the drilling system 10 that is stationary with respect to the shifter lever 18. In operation, as the shifter lever 18 rotates the shift shaft 22, the force element 20 can pivot about the connection point 24a and/or about the connection point 24B. In alternative aspects, the force element 20 can be configured to have sufficient flexibility such that the force element 20 can avoid rotating about the connection point 24a and/or about the connection point 24B.

In other aspects, the force element 20 can comprise a compressible element, which can exert the required force onto the shifter lever 18. For instance, the force element 20 can comprise a spring pivotally secured at the connection point 24B and pivotally secured at another end to the connection point 24a on the shifter lever 18. In operation, a spring can be configured to apply force onto the shifter lever 18 sufficient to generate torque about the shift shaft 22 and maintain the shifter lever 18 and the shift shaft 22 in the first position.

For example and without limitation, a gearbox can require approximately 14 N m (10 ft lb f) to maintain a gear in an engaged position. The shifter lever 18 can apply at least 14N m to the gear in the gearbox to ensure the gear remains in the engaged position. In operation, the force generated by the force element 20 (e.g., spring) can equal approximately the required torque (e.g., 14 N m) divided by the offset distance 26. For instance, for a gearbox that having gears that require 14 N m of torque to remain in an engaged position, the offset distance 26 can be approximately 40 mm and the force generated by the force element 20 can be approximately 349 N. In one aspect, a spring can be used to generate the necessary force. In the above example, a spring with a spring constant k of about 9 to 10 N/mm and a length of approximately 121 (e.g., Trakar Springs C2286-343-1270; C1989-305-1302) can fulfill such requirements.

In even other aspects, the shifter lever 18 can be configured to rotate through an angle of approximately 39° such that, at one extreme of the angle, the shifter lever can be in the first position and, at the other extreme of the angle, the shifter lever can be in the second position. In other words, at a zero point (i.e., 0° angle), the offset distance 26 can be approximately zero. Hence, at the zero point the force element 20 will apply approximately zero torque onto the shifter lever 18. In operation, the shifter lever 18 can rotate approximately 19.5° clockwise into the first position and can rotate approximately 19.5° counterclockwise into the second position.

In yet other aspects, the shifter lever 18 can abut a stop such as a stop 28a or a stop 28b, which can serve as stopping points for the shifter lever 18. The stops 28a, 28b comprise one or more adjustable elements such that the position of the stops 28a, 28b can be adjusted. In one aspect, the stops 28a, 28b can comprise a threaded member that can advance and retract with respect to a particular position in order to alter the stopping point of the shifter lever 18. Thus, the offset distance 26 can vary depending on the particular stopping point, as set by the stops 28a and 28b.

In other aspects, the gear shifting system 16 can further comprise an indicator 30 configured to aid in determining the relationship of the gear shifting lever 18 and shift shaft 22 with the gears in the gearbox. In one aspect, the indicator 30 can have a spring-loaded pin 32 that can be configured to seat into a detent provided on the gearbox as the shifting lever 18 is rotated. Thus, the detents on a housing of the gearbox can be configured to correspond to specific gear settings (e.g., high gear, neutral, and low gear). The indicator 30 and the pin 32 can be used to setup end positions of the shifter lever 18 such that these position correspond to a high and low gears of the gearbox. In an additional or alternative aspect, an actuator 34 can be a linear or an axial actuator having sufficient force to rotate the shifter lever 18. For example and without limitation, the actuator 34 can be a hydraulic cylinder pivotally connected to the shifter lever 18 at an actuator connection point and pivotally connected to a portion of the drilling system 10 that does not move with respect to the shifter lever 18. The hydraulic cylinder can apply linear force on the shifter lever 18 at the actuator connection point. Such connection point can be offset from the shift shaft 22 by an actuator offset distance 36 as measured orthogonally to the cylinder's force vector. More particularly, the actuator offset distance 36 is the perpendicular distance from the force vector of the drive source to the centreline of the rotating shift shaft. The actuator offset distance can be used for tracking the change in torque generated by the spring throughout the stroke of the shift mechanism.

In light of this disclosure, one skilled in the art will appreciate that the various force elements 20 and actuators 34 can be used which can apply various and variable amounts of force onto the gear shifter 18. Similarly, different dimensions can be selected for the offset distance 26 and/or actuator offset distance 36 as well as different force elements. Thus, the gear shifting system 16 can be incorporated into various drill heads 12 and/or gearboxes. For example and without limitation, the gear shifting system 16 can be incorporated with a progressive shift dual-shaft gearbox configured to engage a first set of gears and disengage a second set of gears (and the reverse) in a single motion.

In other aspects of the present disclosure, the gear shifting system 16 can operate in a manual or automated manner. In one aspect, a controller can direct an actuator 34 to rotate the shifter lever 18. In operation, the operator can move shifter lever 18 remotely, by directing a controller to move the actuator 34. Thus, the operator can avoid being in the proximity of the drilling operations during the gear shifting, which can reduce accidents and increase the safety of the operator's environment. Furthermore, automated shifting can reduce or eliminate human error during the shifting process, reducing various incidents that can cause damage to the gears and increasing the lifespan of the gearbox.

In yet other aspects, the actuator 34 can apply a force that can generate greater amount of torque than the torque generated by the force element 20 to rotate the shifter lever 18 between the first and second positions. In additional aspects, the actuator 34 can be configured to produce torque that is greater than the sum of the torque produced by the force element 20 and the torque required to engage and/or disengage the gears within the gearbox. For example and without limitation, engaging and disengaging gears within the gearbox can require the shifter lever 18 to apply about 41 N m (30 ft-lbf) of torque, and the force element 20 can apply about 14 N m (10 ft-lbf) of torque in a direction opposite to the direction that the shifter lever 18 has to rotate from a first position to a second position. Thus, the actuator 34 can be configured to apply approximately 56 N m of torque (or more) to move the shifter lever 18 from one position to another.

In other aspects, the cylinder can be configured to exert a linear force onto the shifter lever 18 in one direction to move the shifter lever 18 from the first position to the second position when the actuator 34 is a cylinder. Subsequently, the cylinder can exert force onto the shifter lever 18 in an opposite direction to move the shifter lever 18 from the second position to the first position. In other aspects, the force exerted by the cylinder onto the shifter lever 18 can be greater than the sum of torques described above (i.e., the torque generated by the force element 20 and the torque required for engagement and disengagement of the gears within the gearbox) divided by the cylinder offset distance. It is also contemplated that the cylinder can generate different amount of force when moving its piston in one direction than in an opposite direction. Consequently, the torque applied to the shifter lever 18 can be different for movements from the first to the second position than the torque applied during the movements from the second to the first position.

In additional or alternative aspects, the shifter lever 18 can be configured to cause shifting of the gears within the gearbox through a manual operation. In one or more aspects, the shifter lever 18 can further comprise a handle having a sufficient length to reduce the amount of force required for an operator to manually rotate the shifter lever 18. In alternative aspects, the handle can couple at the axis of rotation (e.g., to a shaft) such that rotation of the hand can be transmitted into rotation of the shifter lever 18.

In other aspects illustrated in FIG. 2, the force element 20 can apply counterclockwise torque onto the shifter lever 18 to maintain the shifter lever 18 in place and the gears of the gearbox in engagement. Thus, the rotational motion of the gear shifting lever 18 into the second position and corresponding rotation of the shift shaft can cause the gearbox to shift into and remain in a selected gear. In another aspect, the gear shifting system 10 can have a third position configured to set the gearbox into and maintain a neutral gear. In a further aspect, the third position can be located between the first and second positions. The offset distance 26 can be the same in the first position and in the second position. In an alternative aspect, the offset distance 26 in the first position can be different from the offset distance 26 in the second position. In light of the present disclosure, one skilled in the art will appreciate that the offset distance in the first and second positions can be modified to customize the force applied in the first and second positions. Thus, the shifting mechanism 16 can be customized to apply the necessary force to retain the gearbox in the various gear positions whether such force is equal or not.

As described above, the gear shifting system 16 can act to cause engagement and disengagement of gears within the gearbox. In additional aspects, the gear shifting system 16 can be configured to maintain the gears in engagement or disengagement (as applicable) within the gearbox. For example and without limitation, the gear shifting system 16 can cause engagement and disengagement of the gears within the gearbox, through rotation of the shift shaft 22 caused by movement of the shifter lever 18.

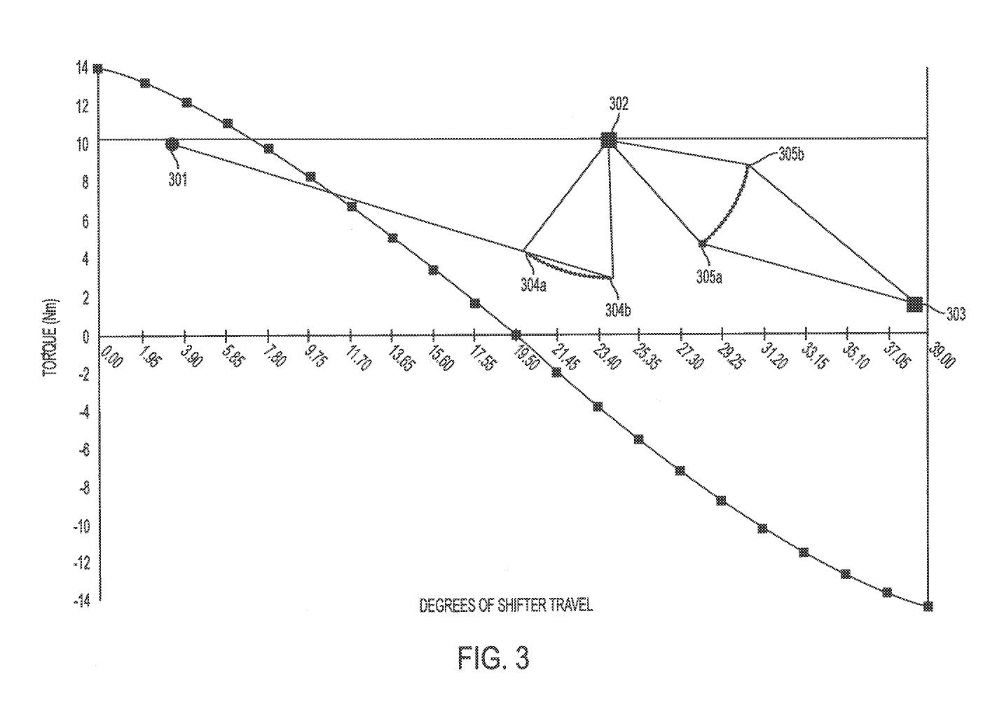

In other aspects, the graph displayed in FIG. 3 illustrates one example of an over-center spring torque versus degrees of shifter travel for implementations of the present disclosure described above. Here, the drive source connection to the drill head is represented by a first point 301, the shifter lever connection to the shifter lever is represented by a second point 302, and the force element connection to the shifter lever is represented by a third point 303. In one aspect, the actuator 34 associated with the drive source and connected to the shifter lever can be configured to rotate from a first actuator position 304a, which corresponds to a low gear, to a second actuator position, which corresponds to a high gear 304b. Likewise, the force element connected to the shifter lever 18 at connection point 24a can be configured to rotate from a first force element position 305a, which corresponds to a low gear, to a second force element position 305b, which corresponds to a high gear. Thus, the over center spring torque path corresponding to a low gear setting follows the path from the first point 301 to the first actuator position 304a to the second point 302 to the first force element position 305a to the third point 303. Similarly, the over center spring torque path corresponding to a high gear setting follows the path from the first point 301 to the second actuator position 304b to the second point 302 to the second force element position 305b to the third point 303.

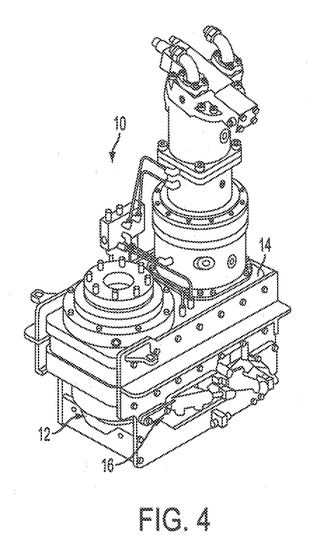

In further aspects illustrated in FIG. 4, the drilling system 10 can incorporate the gear shifting system 16. A drill rig can incorporate such drilling system 10 for various drilling operations. The gear shifting system 16 can provide numerous advantages including, but not limited to, facilitating drilling operations at multiple speeds, changing drill speed in a safe manner, and reducing gear damage that can result from engagement and/or disengagement of gears within the gearbox during operation as well as from forces applied to the gears in order to maintain engagement thereof.

The present invention can thus be embodied in other specific forms without departing from its spirit or essential characteristics. The described aspects are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A gear shifting system for engaging, disengaging, and maintaining engaged gears in a continuous engagement within a gearbox of a drill head, the system comprising:
a shifter lever having a center of rotation that is rotatably secured to a gearbox wherein rotation of the shifter lever to a first position engages a first gear and rotation of the shifter lever to a second position disengages the first gear and engages a second gear; and
a force element pivotally secured to the shifter lever;
wherein the force element applies a force onto the shifter lever when the shifter lever is in the first position or in the second position.

2. The gear shifting system of claim 1, wherein the force element applies a first force at the first position and a second force at the second position of the shifter lever.

3. The gear shifting system of claim 2, wherein the first force and the second force applied by the force element can be adjusted to maintain the respective first and second gears in engagement.

4. The gear shifting system of claim 1, further comprising an actuator pivotally secured to the shifter lever and configured to move the shifter lever from the first position into the second position and from the second position into the first position.

5. The gear shifting system of claim 1, wherein the force element applies a force onto the shifter lever at a predetermined distance from the center of rotation of the shifter lever.

6. The gear shifting system of claim 5, wherein the force is a linear force.

7. The gear shifting system of claim 1, wherein the shifter lever further comprises a shift shaft and the force element is pivotally connected to the shift shaft at a connection point.

8. The gear shifting system of claim 7, wherein the connection point is offset from the shift shaft by a predetermined distance measured perpendicularly to a direction parallel to the force applied by the force element.

9. The gear shifting system of claim 1, wherein the force element comprises a compressible element configured to exert force on the shifter lever.

10. The gear shifting system of claim 9, wherein the compressible element comprises a spring.

11. The gear shifting system of claim 10, wherein the spring is pivotally secured at the connection point.

12. The gear shifting system of claim 1, wherein the shifter lever is configured to rotate through a predetermined angle where a first extreme of the angle corresponds to the first position and a second extreme of the angle corresponds to the second position.

13. The gear shifting system of claim 12, wherein the shifter lever is configured to rotate through a predetermined angle of about 39 degrees.

14. The gear shifting system of claim 12, further comprising an adjustable first stop configured to abut the shifter lever at the first extreme of the predetermined angle.

15. The gear shifting system of claim 14, wherein the stop comprises a threaded member operable to be adjusted to alter the predetermined angle of the shifter lever.

16. The gear shifting system of claim 12, further comprising an adjustable second stop configured to abut the shifter lever at the second extreme of the predetermined angle.

17. The gear shifting system of claim 1, further comprising an indicator operable to indicate at least the relative position of the shifter lever to at least one gear located in the gearbox.

18. The gear shifting system of claim 1, wherein the gear shifting system is configured for automatic operation.

19. A drilling system for mounting on a drill rig, the drilling system comprising:
a drill head;
a gearbox comprising a plurality of gears and configured to engage the drill head;
a drive source in operative connection with the gearbox; and
a gear shifting system in operative connection with at least one gear of the plurality of gears of the gearbox,
wherein the gear shifting system comprises:
a shifter lever configured to engage and disengage at least one gear of the plurality of gears of the gearbox; and
a force element configured to apply force onto the shifter lever such as to maintain at least one gear of the plurality of gears in engaged position.

20. The drilling system of claim 19, wherein the gear shifting system is configured for manual operation.

21. The drilling system of claim 19, wherein the gear shifting system is configured for automatic operation.
